(19) United States
(12) Patent Application Publication
(10) Pub. No.: US 2024/0267933 A1
(43) Pub. Date: Aug. 8, 2024

(54) APPARATUS AND METHOD FOR TRANSMITTING OR RECEIVING SIGNAL IN WIRELESS COMMUNICATION SYSTEM

(71) Applicant: LG ELECTRONICS INC., Seoul (KR)

(72) Inventors: Jong Ku LEE, Seoul (KR); Sunam KIM, Seoul (KR); Sung Ryong HONG, Seoul (KR)

(73) Assignee: LG ELECTRONICS INC., Seoul (KR)

(21) Appl. No.: 18/557,885

(22) PCT Filed: May 14, 2021
(86) PCT No.: PCT/KR2021/006084

§ 371 Date: Oct. 27, 2023

(51) Int. Cl. H04W 72/232; H04W 72/04

(52) U.S. Cl. CPC H04W 72/232; H04W 72/04

(57) ABSTRACT

In order to transmit and receive data in a wireless communication system, a method performed by a base station comprises transmitting a downlink control information (DCI) and transmitting a plurality of transport blocks through resources indicated by the DCI. The plurality of transport blocks may comprise a first-type transport block and at least one second-type transport block, the DCI may comprise modulation order and coding rate information of the first-type transport block, and the first-type transport block may comprise coding rate information of the at least one second-type transport block.

### CROSS-REFERENCE TO RELATED APPLICATION(S)

This application is the National Stage filing under 35 U.S.C. 371 of International Application No. PCT/KR2021/006084, filed on May 14, 2021, the contents of which is hereby incorporated by reference herein in its entirety.

### TECHNICAL FIELD

The following description relates to a wireless communication system and to an apparatus and method for transmitting and receiving data in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure can provide an apparatus and method for efficiently transmitting and receiving data in a wireless communication system.

The present disclosure can provide an apparatus and method for efficiently transmitting multiple quality of service (QoS) data in a wireless communication system.

The present disclosure can provide an apparatus and method for increasing system capacity in a wireless communication system.

The present disclosure can provide an apparatus and method for transmitting a plurality of transport blocks (TBs) in one unit in a wireless communication system.

The technical objects to be achieved in the present disclosure are not limited to the above-mentioned technical objects, and other technical objects that are not mentioned may be considered by those skilled in the art through the embodiments described below.

As an example of the present disclosure, a method performed by a base station in a wireless communication system may comprise transmitting a downlink control information (DCI) and transmitting a plurality of transport blocks through resources indicated by the DCI. The plurality of transport blocks may comprise a first-type transport block and at least one second-type transport block, the DCI may comprise modulation order and coding rate information of the first-type transport block, and the first-type transport block may comprise coding rate information of the at least one second-type transport block.

As an example of the present disclosure, a method performed by a terminal in a wireless communication system may comprise receiving a downlink control information (DCI) and receiving a plurality of transport blocks through resources indicated by the DCI. The plurality of transport blocks comprises a first-type transport block and at least one second-type transport block, the DCI may comprise modulation order and coding rate information of the first-type transport block, and the first-type transport block may comprise coding rate information of the at least one second-type transport block.

As an example of the present disclosure, a base station in a wireless communication system comprises a transceiver and a processor connected to the transceiver. The processor may transmit a downlink control indicator (DCI) and transmitting a plurality of transport blocks through resources indicated by the DCI. The plurality of transport blocks may comprise a first-type transport block and at least one second-type transport block, the DCI may comprise modulation order and coding rate information of the first-type transport block, and the first-type transport block may comprise coding rate information of the at least one second-type transport block.

As an example of the present disclosure, a terminal in a wireless communication system comprises a transceiver and a processor connected to the transceiver. The processor may receive a downlink control information (DCI) and receive a plurality of transport blocks through resources indicated by the DCI. The plurality of transport blocks may comprises a first-type transport block and at least one second-type transport block. The DCI may comprise modulation order and coding rate information of the first-type transport block, and the first-type transport block may comprise coding rate information of the at least one second-type transport block.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, a wireless communication system can efficiently support multiple quality of services (QoSs). Specifically, in a wireless communication system, a base station and a terminal can support multiple QoS transmission without additionally using a control channel.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of a hand-held device applicable to the present disclosure.

FIG. 5 is a view showing an example of a car or an autonomous driving car applicable to the present disclosure.

FIG. 6 is a view showing an example of artificial intelligence (AI) device applicable to the present disclosure.

FIG. 7 is a view showing physical channels applicable to the present disclosure and a signal transmission method using the same.

FIG. 8 is a view showing an example of a communication structure providable in a 6th generation (6G) system applicable to the present disclosure.

FIG. 9 is a view showing an electromagnetic spectrum applicable to the present disclosure.

FIG. 10 is a view showing a THz communication method applicable to the present disclosure.

FIGS. 11A and 11B are diagrams showing examples of media access control (MAC) protocol data units (PDUs) used in a 5G communication system.

FIG. 12 is a diagram showing an example of code block group-based transmission in a 5G communication system.

FIG. 13 is a diagram showing an example of a transmission structure according to an embodiment of the present disclosure.

FIG. 14 is a diagram showing an example of a method of transmitting data according to an embodiment of the present disclosure.

FIG. 15 is a diagram showing an example of a method of receiving data according to an embodiment of the present disclosure.

FIG. 16 is a diagram showing an example of a MAC/physical (PHY) data structure according to an embodiment of the present disclosure.

FIG. 17 is a diagram showing an example of a procedure of processing length information of a first-type transport block according to an embodiment of the present disclosure.

FIG. 18 is a diagram showing another example of a MAC/PHY data structure according to an embodiment of the present disclosure.

FIG. 19 is a diagram showing an example of a procedure for transmitting data based on a channel coding scheme for each LCG according to an embodiment of the present disclosure.

FIG. 20 is a diagram showing an example of a method of transmitting data according to an embodiment of the present disclosure.

FIG. 21 is a diagram showing an example of transport block mapping based on latency priority according to an embodiment of the present disclosure.

FIG. 22 is a diagram showing an example of a method of retransmitting a transport block according to an embodiment of the present disclosure.

FIG. 23 is a diagram showing another example of a method of retransmitting a transport block according to an embodiment of the present disclosure.

FIG. 24 is a diagram showing an example of transmission of transport blocks without decoding failure according to an embodiment of the present disclosure.

FIG. 25 is a diagram showing an example of transmission of transport blocks when decoding of a second-type transport block fails according to an embodiment of the present disclosure.

FIG. 26 is a diagram showing an example of transmission of transport blocks when decoding of a first-type transport block fails according to an embodiment of the present disclosure.

FIG. 27 is a diagram showing another example of transmission of transport blocks when decoding a first-type transport block fails according to an embodiment of the present disclosure.

FIG. 28 is a diagram showing an example of transmission of transport blocks when detection of control information fails according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3^{rd} Generation Partnership Project (3GPP) system, a 3GPP Long Term Evolution (LTE) system, 3GPP 5^{th} generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

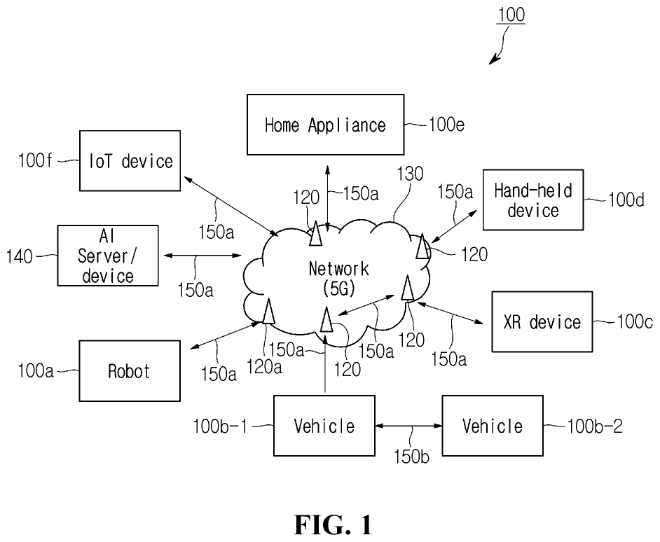

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.). resource allocation processes, etc. may be performed.

### Communication System Applicable to the Present Disclosure

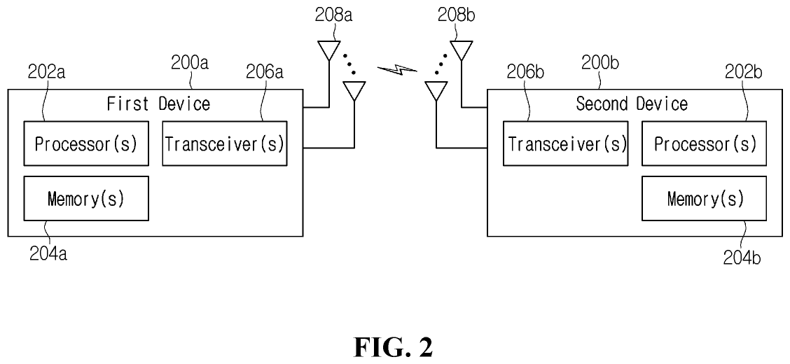

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

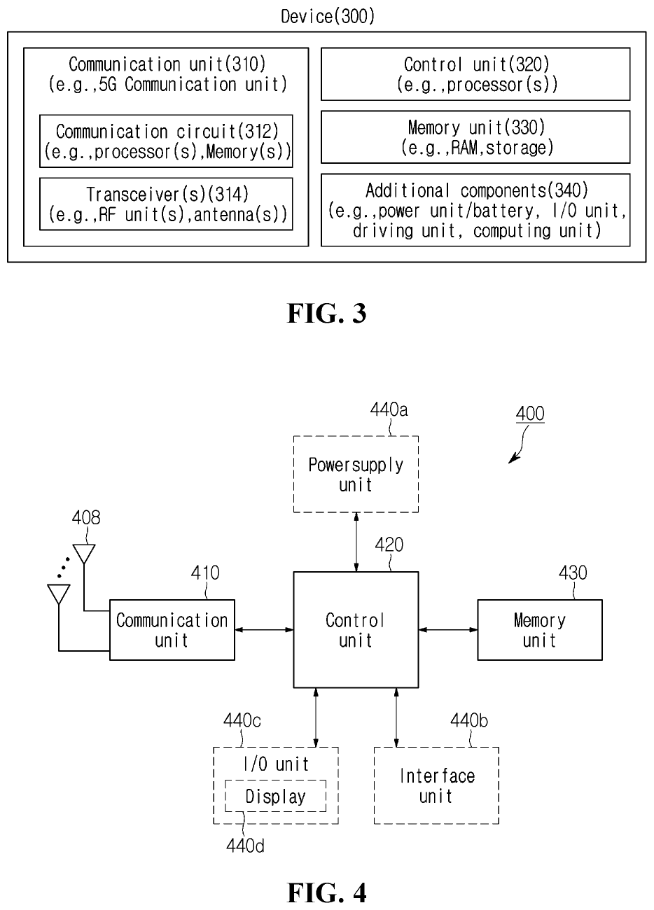

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-held Device Applicable to the Present Disclosure

FIG. 4 is a view showing an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

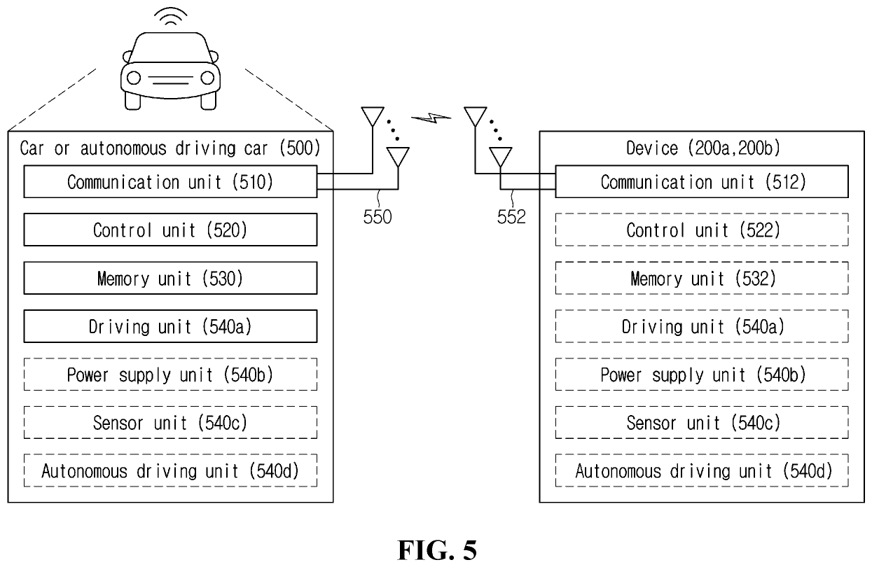

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

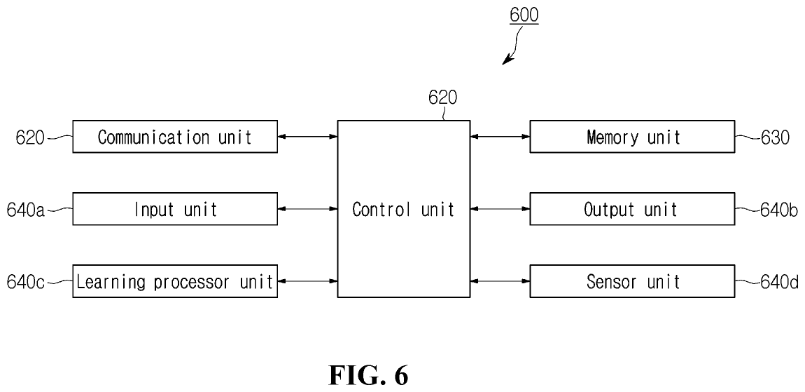

FIG. 6 is a view showing an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

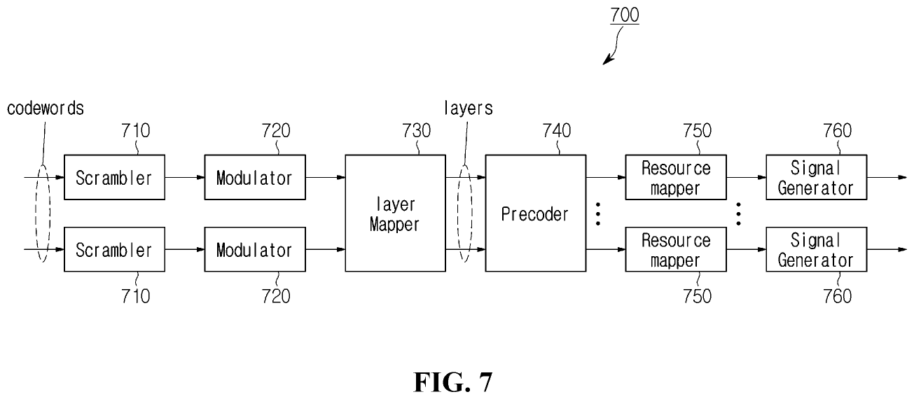

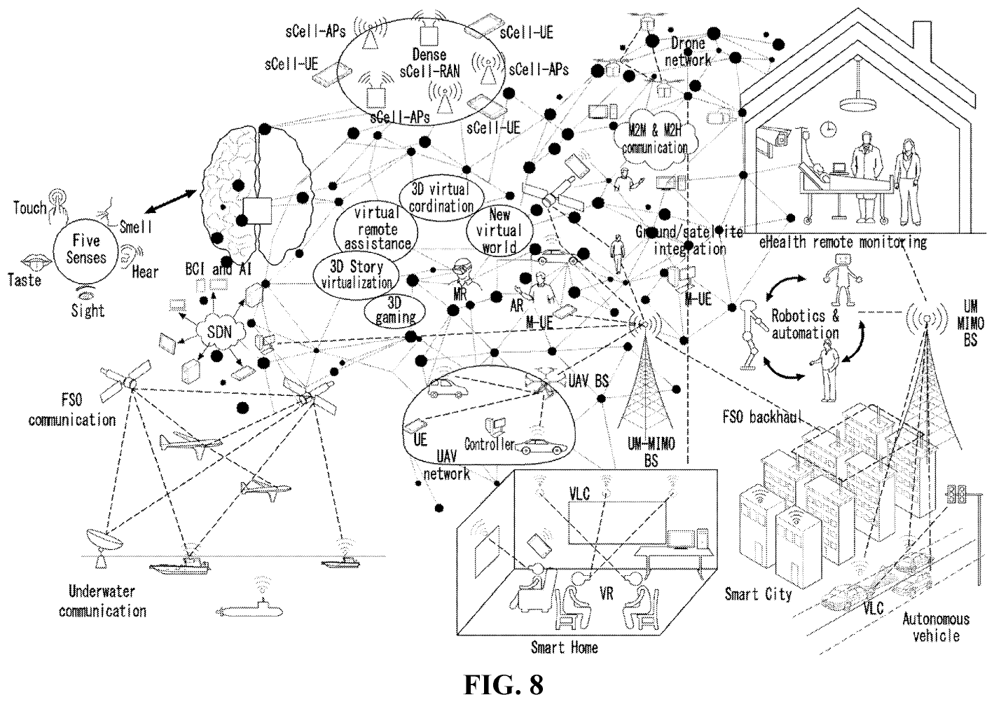

FIG. 7 is a view showing a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

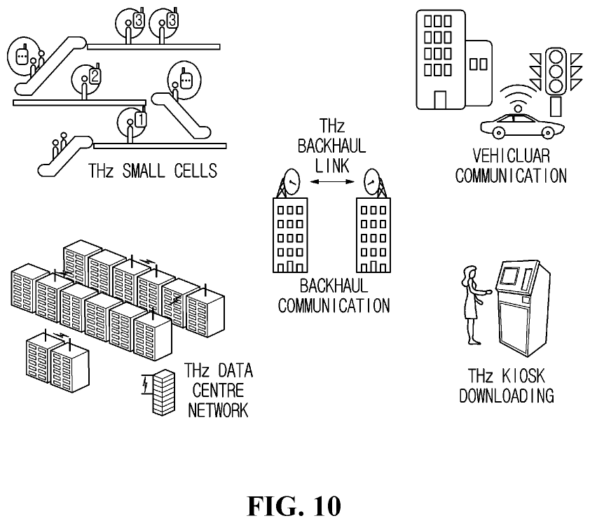

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 10. Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | |
|---|---|
| Per device peak data rate | 1 Tbps |
| E2E latency | 1 ms |
| Maximum spectral efficiency | 100 bps/Hz |
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

FIG. 10 illustrates an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) communication

THz communication is applicable to the 6G system. For example, a data rate may increase by increasing bandwidth. This may be performed by using sub-THz communication with wide bandwidth and applying advanced massive MIMO technology.

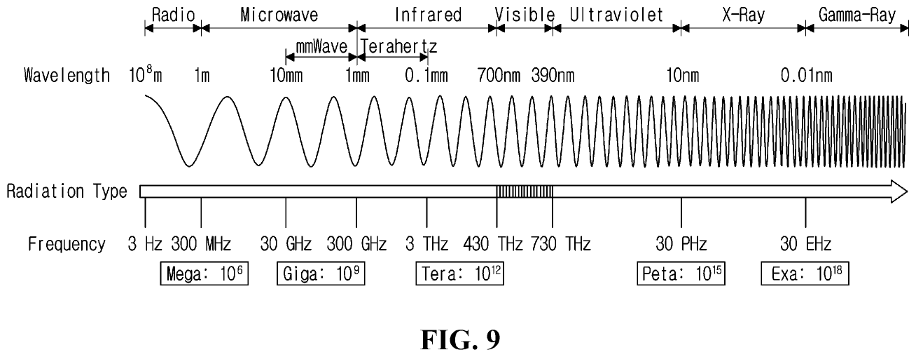

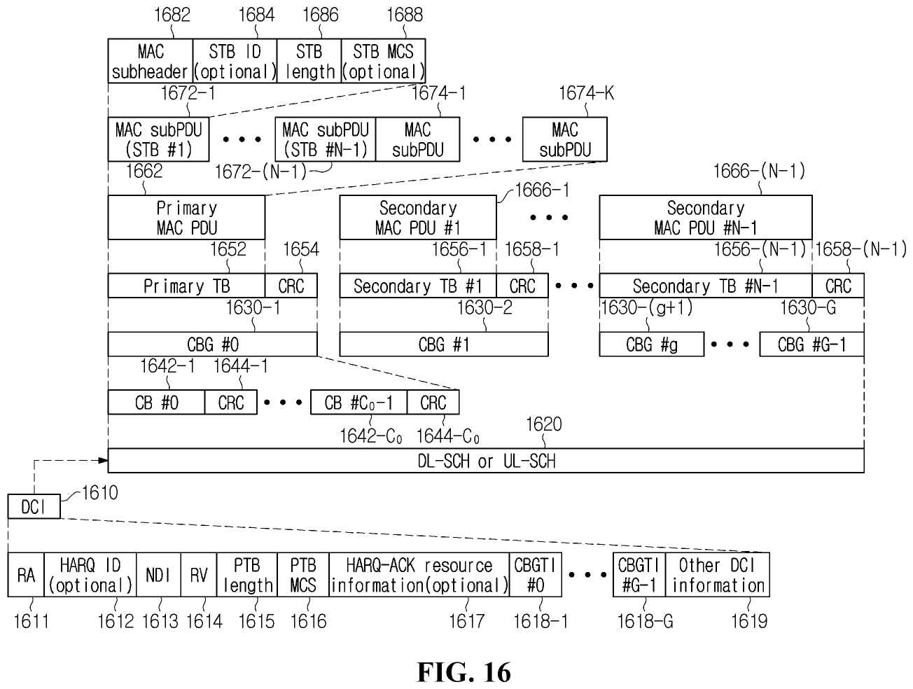

FIG. 9 is a view showing an electromagnetic spectrum applicable to the present disclosure. For example, referring to FIG. 16, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 is a view showing a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Specific Embodiment of the Present Invention

The present disclosure relates to efficient transmission and reception of data in a wireless communication system and specifically to technology for efficiently providing one terminal with a plurality of services requiring different quality of services (QoSs) or services requiring various QoSs in a wireless communication system.

In radio access networks such as 4G LTE and 5G NR, QoS is managed by Data Radio Bearer (DRB). A RLC layer and a MAC layer control transmission quality for each logical channel corresponding to each DRB. The MAC layer may multiplex two or more logical channels into one transport channel. When two or more logical channels exist, the MAC layer performs scheduling according to priority, generates a MAC PDU according to the scheduling result, and then forwards it to a physical (PHY) layer. The physical layer treats one MAC PDU as one transport block (TB), adds a cyclic redundancy check (CRC) to each transport block, performs channel coding, and performs transmission through a physical channel such as a physical downlink shared channel (PDSCH) or a physical uplink shared channel (PUSCH). In general, a transmission technique such as a transmit time interval (TTI) and a modulation and coding scheme (MCS) is determined according to target transmission quality (e.g., block error rate (BLER)) and wireless link quality such as a transmission latency time and a signal to interference and noise ratio (SINR).

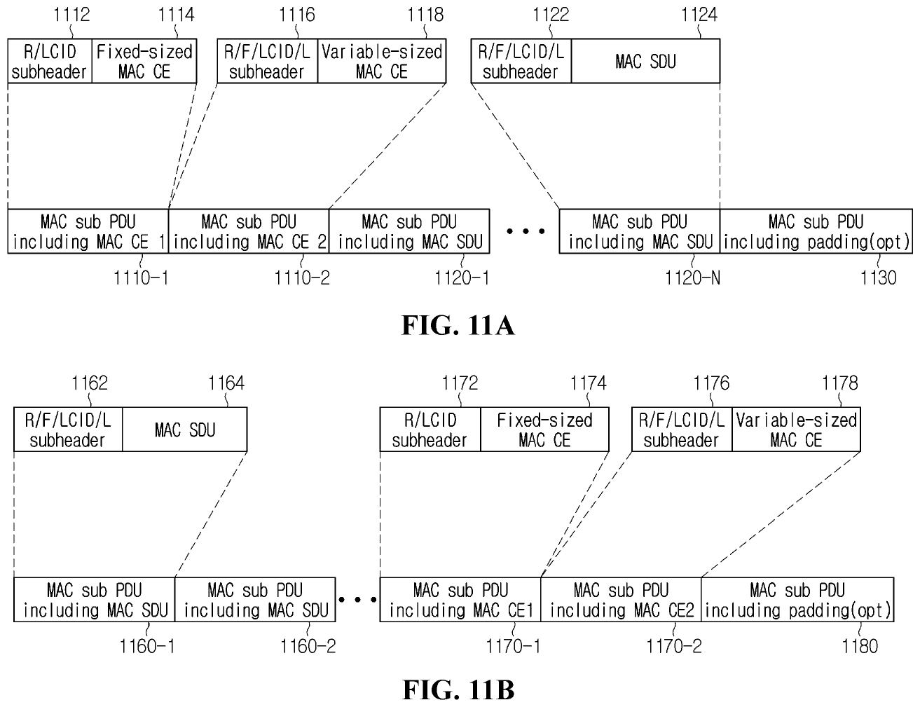

An example of a 5G NR MAC PDU is shown in FIGS. 11A and 11B. FIGS. 11A and 11B are diagrams showing examples of MAC PDUs used in a 5G communication system. FIG. 11a illustrates a downlink MAC PDU, and FIG. 11b illustrates an uplink MAC PDU. Referring to FIG. 11a, the downlink MAC PDU may include MAC sub PDUs 1110-1 and 1110-2 including a MAC control element (CE), and MAC sub PDUs 1120-1 to 1120-N including a MAC SDU, and a MAC sub PDU1130 including 0 bytes or more of padding. In addition, the MAC sub PDU 1110-1 may include an R/LCID subheader 1112 and a fixed-sized MAC CE 1114, and the MAC sub PDU 1110-2 may include an F/LCID/L subheader 1116 and a variable-sized MAC CE 1118. The MAC sub PDU 1120-N may include an R/F/LCID/L subheader 1122 and a MAC SDU 1124.

Referring to FIG. 11b, the uplink MAC PDU may include MAC sub PDUs 1160-1 and 1160-2 including a MAC SDU, MAC sub PDUs 1170-1 and 1170-2 including a MAC CE, and a MAC sub PDU 1180 including 0 bytes or more of padding. In addition, the MAC sub PDU 1160-1 may include an R/F/LCID/L subheader 1162 and a MAC SDU 1164, and the MAC sub PDU 1170-1 may include an R/LCID subheader 1176 and a fixed-sized MAC CE 1174, and the MAC sub PDU 1170-2 may include an R/F/LCID/L subheader 1176 and a variable-sized MAC CE 1178.

A radio access system may use various transmission techniques to maintain transmission quality even in a radio wave environment changing due to the movement of the terminal. For example, as a representative transmission technique, adaptive modulation and coding (AMC) and hybrid automatic repeat request (HARQ) may be used.

AMC is a technology that selectively applies an appropriate MCS (modulation and coding scheme) depending on radio link quality. When a terminal measures channel quality (e.g., SINR) and reports a channel quality indicator (CQI) to a base station, the base station determines an appropriate modulation order, coding scheme, and coding rate according to the channel quality. By selecting an appropriate MCS for the channel quality, it is possible to increase data transmission while efficiently lowering the error rate. However, even if AMC is applied, there is still a possibility that an error may occur in a single transmission, and there is a limitation that the resources required to reduce the error rate to a very low level increase significantly. To improve such problems, HARQ techniques are generally used along with AMC.

HARQ is a technique obtained by combining forward error correction (FEC) and automatic repeat request (ARQ). A transmitter transmits data encoded with an FEC code. A receiver checks whether an error occurs in a data transport block by decoding the received signal, and requests retransmission from the transmitter when the error is detected. The transmitter retransmits data encoded with an FEC code, and the receiver combines a previously received signal with a newly received signal and then decodes it, thereby increasing coding gain and lowering error probability. During retransmission, a chase combining (CC) method that transmits the same encoded data as previously transmitted data or an incremental redundancy (IR) method that transmits encoded data including a new parity bit may be used. The IR method is somewhat more complicated than the CC method, but has better performance.

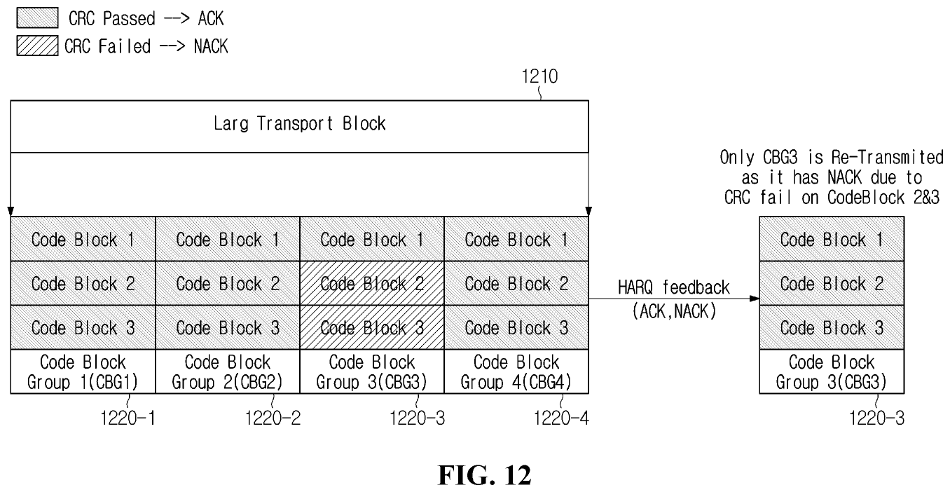

As the transmission speed of the communication system increases and the size of the transport block increases, a technique of splitting one transport block into multiple code blocks (CBs) and then transmitting them is used to increase retransmission efficiency. The transmitter adds CRC not only to the entire transport block but also to each code block, and the receiver checks the CRC for each code block and requests retransmission only for the code block in which an error occurred. As a result, radio resources required for retransmission can be saved and transmission efficiency can be improved. However, since the receiver shall transmit whether to perform retransmission for each code block to the transmitter, there is a disadvantage that the amount of radio resources required increases. In the case of 5G NR, as the transmission speed increases, the size of the transport block becomes larger, and the number of code blocks and the amount of retransmission request information also increase accordingly. Accordingly, the 5G NR system adopted a technique of performing retransmission in units of code block groups (CBGs) obtained by combining a plurality of code blocks. An example of a transmission technique based on a code block group in 5G NR is shown in FIG. 12 below.

FIG. 12 is a diagram showing an example of code block group-based transmission in a 5G communication system. Referring to FIG. 12, a transport block 1210 is split into a plurality of code blocks and three code blocks form one code block group. In the example of FIG. 12, four code block groups 1220-1 to 1220-4 are formed. When the transport block 1210 is transmitted, a receiver determines whether decoding is successful for each code block. In the example of FIG. 12, negative acknowledge (NACK) for two code blocks included in the third code block group 1220-3 occurs and thus the third code block group 1220-3 is retransmitted.

A base station and a terminal share information on transmission techniques through an RRC message and a physical channel such as PDCCH and MAC CE. In particular, in order to quickly cope with changes in channel environment, AMC and HARQ information are generally sent through a PDCCH. The PDCCH includes essential information for transmitting data through a PDSCH and a PUSCH and thus is designed to have high transmission reliability even if transmission efficiency is somewhat reduced. As wireless transmission technology is developed and becomes complicated, the amount of control information transmitted through the PDCCH is gradually increasing.

With development of wireless communication technology and hardware, one terminal can various services requiring different QoS or provide services composed of functions requiring various QoS. For example, a smartphone user may use an SNS and perform Internet search while watching a video. For example, in the case of AR/VR services, data transmission speed and latency time required for visual data and auditory data may be different from each other. Meanwhile, as various types of devices including autonomous vehicles as well as devices directly used by people, such as smartphones, adopt wireless communication functions, the number of terminals connected to a wireless communication network is expected to increase rapidly. Accordingly, the need for radio access technology that can support multiple QoS transmission for a large number of terminals is increasing.

In conventional radio access technology such as 4G LTE or 5G NR, data included in one transport block is transmitted according to the same transmission technique (e.g., MCS, HARQ parameter, etc.). Accordingly, even if transmission quality (e.g., BLER, latency time, etc.) required for each logical channel is different, all logical channels have physically the same transmission quality. Such a transmission method does not cause a problem when the transport block is small but may cause the following deterioration in transmission efficiency and transmission quality when the transport block becomes larger.

First, it may be difficult to efficiently allocate radio resources. To obtain a target BLER required by all logical channels, MCS shall be selected based on the lowest target BLER. In this case, an excessive amount of radio resources may be allocated to a logical channel requiring a high target BLER. Conversely, when MCS is selected based on the high target BLER, the BLER may increase and thus transmission latency of data requiring low BLER may occur and in the worst case, transmission failure may occur. When transmission failure occurs in the physical layer, the transmission failure shall be recovered by the ARQ procedure of a higher layer such as RLC, thereby requiring additional radio resources and significantly increasing transmission latency.

Second, when an error occurs in some code blocks, the entire transport block cannot be forwarded to the higher layer and thus transmission latency increases. For example, when a logical channel (hereinafter ‘logical channel 1’) requiring low transmission latency and a logical channel (hereinafter ‘logical channel 2’) that is relatively insensitive to transmission latency are transmitted through one transport block, even if code blocks and code block groups including logical channel 1 are received without error, if errors occur in code blocks and code block groups including logical channel 2, data of logical channel 1 is not forwarded to the MAC layer. When the errors of all code blocks and code block groups including logical channel 2 are corrected by retransmission, the entire transport block may be sent to the MAC layer and thus average transmission latency of logical channel 1 may increase. Transmission latency due to errors of some code blocks may become more frequent as the size of the transport block increases. This is because when the transport block becomes larger, the number of split code blocks increases and a probability that the entire transport block, that is, all code blocks are decoded without error in the first transmission decreases.

The above-described problems may be solved by generating and transmitting transport blocks according to QoS requirement. However, this may cause a problem of using as many control channels (e.g., PDCCH) as the number of transport blocks. The control channel is a non-traffic channel that competitively occupies resources with a channel for actually transmitting data and an increase in resources allocated to the control channel may cause a decrease in overall system capacity. In addition, from the terminal's perspective, since the number of control channels and data transmission channels to be processed within one TTI increases, system complexity and power usage may increase. Such problems are expected to become more important as the number of services simultaneously supported by one terminal increases and the number of terminals simultaneously supported in a wireless communication network increases.

Therefore, the present disclosure proposes technology for transmitting a plurality of logical channels having different QoS requirements through a data channel (e.g., PDSCH, PUSCH, etc.) corresponding to control information (e.g., DCI) transmitted through one control channel (e.g., PDCCH).

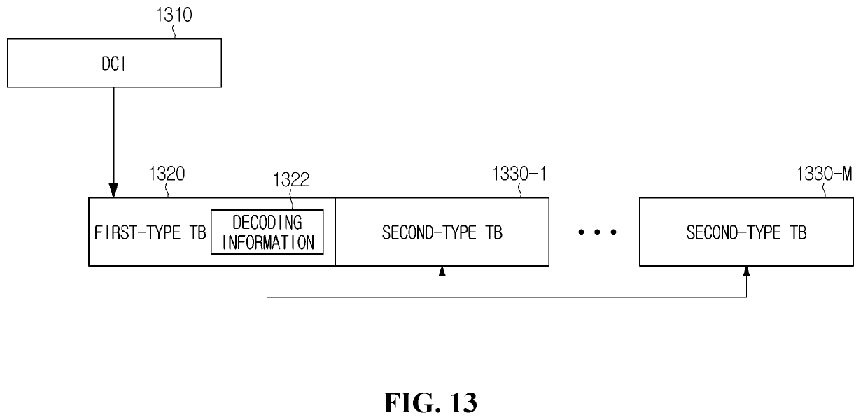

FIG. 13 is a diagram showing an example of a transmission structure according to an embodiment of the present disclosure. FIG. 13 exemplifies a DCI 1310 and a plurality of transport blocks 1320 and 1330-1 to 1330-M.

Referring to FIG. 13, time-frequency resources are allocated by the DCI 1310. According to an embodiment, a plurality of transport blocks 1320 and 1330-1 to 1330-M is transmitted through time-frequency resources allocated by one DCI 1310. Here, the plurality of transport blocks 1320 and 1330-1 to 1330-M includes a first-type transport block 1320 and second-type transport blocks 1330-1 to 1330-M.

Each of the first-type transport block 1320 and the second-type transport blocks 1330-1 to 1330-M includes one MAC PDU. In this case, the first-type transport block 1320 includes a first-type of MAC PDU and the second-type transport blocks 1330-1 to 1330-M respectively includes second-types MAC PDUs. Each of the second-type MAC PDUs may include data having the same or similar QoS requirements, for example, data of logical channels belonging to the same logical channel group (LCG). The first-type MAC PDU also includes data having the same or similar QoS requirements and includes decoding information 1322 (e.g., modulation order, coding scheme, coding rate, etc.) of each of the second-type transport blocks 1330-1 to 1330-M according to an embodiment. Accordingly, while reducing the burden of the DCI 1310 having to include decoding information of all of the plurality of transport blocks 1320 and 1330-1 to 1330-M, the plurality of transport blocks 1320 and 1330-1 to 1330-M may depend on one DCI 1310.

As shown in FIG. 13, two types of transport blocks and two types of MAC PDUs are defined. In the case of FIG. 13, the expression of the first type/second type is used to classify the transport block or the MAC PDU, but the first type/second type may be referred to as primary/secondary or mutually distinguishable terms similar thereto.

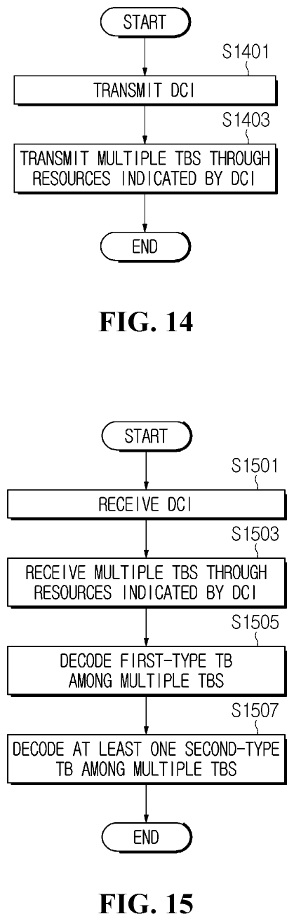

FIG. 14 is a diagram showing an example of a method of transmitting data according to an embodiment of the present disclosure. FIG. 14 exemplifies a method performed by a base station.

Referring to FIG. 14, in step S1401, the base station transmits a DCI. The DCI includes resource allocation information for a plurality of transport blocks to be transmitted subsequently. According to an embodiment, the DCI may include decoding information (e.g., MCS level) of a first-type transport block among the plurality of transport blocks. According to another embodiment, the DCI may further include at least part (e.g., modulation order) of decoding information of a second-type transport block.

In step S1403, the base station transmits the plurality of transport blocks through resources indicated by the DCI. The base station may transmit a first-type transport block and at least one second-type transport block through resources. Here, the first-type transport block may include at least part (e.g., at least one of modulation order, coding scheme or coding rate) of the decoding information of at least one second-type transport block.

FIG. 15 is a diagram showing an example of a method of receiving data according to an embodiment of the present disclosure. FIG. 15 exemplifies a method performed by a terminal.

Referring to FIG. 15, in step S1501, the terminal receives a DCI. The DCI includes resource allocation information for a plurality of transport blocks to be transmitted subsequently. According to an embodiment, the DCI may include decoding information (e.g., MCS level) of a first-type transport block among the plurality of transport blocks. According to another embodiment, the DCI may further include at least part (e.g., modulation order) of decoding information of a second-type transport block.

In step S1503, the terminal receives a plurality of TBs through resources indicated by the DCI. The terminal may receive a first-type transport block and at least one second-type transport block through resources. Here, the first-type transport block may include at least part (e.g., at least one of modulation order, coding scheme or coding rate) of the decoding information of at least one second-type transport block.

In step S1505, the terminal decodes the first-type transport block among the plurality of transport blocks. The terminal may decode the first-type transport block based on control information included in the DCI. Through this, the terminal may obtain data included in the first-type transport block and process it in a higher layer. Here, processing the data included in the first-type transport block in the higher layer may be performed prior to decoding of at least one second-type transport block. In addition, the terminal may obtain control information, that is, decoding information, of at least one second-type transport block included in the first-type transport block.

In step S1506, the terminal decodes at least one second-type transport block among the plurality of transport blocks. The terminal may decode the second-type transport block based on the control information included in the first-type transport block. Accordingly, the data included in the at least one second-type transport block may be obtained and processed in the higher layer. In this case, when a plurality of second-type transport blocks is present. the terminal may decode each of the second-type transport blocks and independently process it in the higher layer.

The embodiments described with reference to FIGS. 14 and 15 are related to operations of the base station and the terminal performing downlink communication. Similarly, uplink communication may also include DCI transmission and transmission of the plurality of transport blocks based on the DCI. However, the DCI is transmitted by the base station and the plurality of transport blocks is transmitted by the terminal. Specifically, the base station may transmit a DCI including control information for the first-type transport block and resource allocation information to the terminal, and the terminal may transmit a first-type transport block and at least one second-type transport block to the base station based on the DCI. In this case, the DCI may not include encoding/decoding information of at least one second-type transport block or may include some thereof. At least part of the encoding/decoding information of at least one second-type transport block not included in the DCI may be determined based on the control information of the first-type transport block according to a predefined or pre-signaled rule.

According to the above-described embodiments, the plurality of transport blocks may be transmitted based on one DCI. For transmission according to various embodiments, the data structure of the MAC layer and the physical (PHY) layer may be newly defined.

The MAC layer may transmit one primary MAC PDU and 0 or at least one secondary MAC PDU through one transport channel (e.g., DL-SCH or UL-SCH). The transport block corresponding to the primary MAC PDU is called a primary transport block (primary TB, PTB) (hereinafter ‘PTB’), and other transport blocks are called secondary transport blocks (secondary TB, STB) (hereinafter ‘STB’). The PHY layer attaches a transport block CRC to each transport block. Each transport block corresponds to one or more code block groups. Each code block group includes at least one code block. When a code block group includes a plurality of code blocks, a CRC may be added to each code block. The MAC/PHY data structure of the above-described structure is shown in FIG. 16 below.

FIG. 16 is a diagram showing an example of a MAC/PHY data structure according to an embodiment of the present disclosure. FIG. 16 exemplifies a transmission structure of a MAC layer and a PHY layer that may support multiple QoS data transmission as a pair of DCI and transport channel. In FIG. 16, a first-type transport block is referred to as PTB and a second-type transport block is referred to as STB.

Referring to FIG. 16, the DCI 1610 is related to a shared channel 1620 (e.g., DL-SCH or UL-SCH) transmitted through resources indicated by the DCI 1610. The DCI 1610 includes fields such as resource allocation (RA) 1611, HARQ ID 1612, new data indicator (NDI) 1613, redundancy version (RV) field 1614, PTB length 1615, PTB MCS 1616, HARQ-ACK resource information 1617, code block group transmission information (CBGTI) 1618-1 to 1618-G, and other DCI information 1619.

The RA 1611 indicates the location of resource allocated for PDSCH or PUSCH for transmitting the SCH 1620. The HARQ ID 1612 includes identification information (e.g., process number) of the HARQ process and may be omitted in some cases. For example, if synchronous HARQ (synchronous HARQ) is used, the HARQ ID 1612 may be omitted. The NDI 1613 indicates whether to retransmit at least one transport block included in the SCH 1620. The RV 1614 indicates the RV of at least one transport block included in the SCH 1620.

The PTB length 1615 indicates the length of the PTB included in the SCH 1620. The PTB MCS 1616 indicates the modulation order, coding scheme, and coding rate of the PTB included in the SCH 1620. That is, the PTB MCS 1616 includes information related to the modulation order, coding scheme, and coding rate applied to the PTB 1652. According to another embodiment, the base station may forward some of the modulation order, coding scheme, and coding rate applied to the PTB 1652 to the terminal through an RRC message or MAC CE rather than the DCI 1610. For example, depending on the channel status or combination of supported services, the channel coding algorithm may be forwarded through an RRC message or MAC CE, and only the modulation order and coding rate may be forwarded to the DCI 1610.

The HARQ-ACK resource information 1617 indicates the location of resource for ACK/NACK transmission corresponding to at least one transport block included in the SCH 1620, and may be omitted in some cases. In other words, the HARQ-ACK resource information 1617 indicates radio resources for forwarding HARQ-ACK information of the PTB 1652 and STBs 1656-1 to 1656-(N-1). HARQ-ACK for the PTB 1652 and HARQ-ACK for the STBs 1656-1 to 1656-(N-1) may be transmitted using different radio resources. For example, in the case of downlink, PTB HARQ-ACK may be transmitted first through TTI before STB HARQ-ACK. In cases where explicit HARQ-ACK is not required, such as in the uplink of 5G NR, HARQ-ACK resource information may not be transmitted. Alternatively, for example, the location of resource for ACK/NACK transmission may be indicated through separate signaling rather than the DCI 1610, and in this case, the HARQ-ACK resource information 1617 may be omitted. Each of the CBGTIs 1618-1 to 1618-G indicates whether a CBG corresponding to the corresponding location is present in the SCH 1620.

The SCH 1620 includes a plurality of CBGs 1630-1 to 1630-G, and CBG #0 1630-1 includes a plurality of CBs 1642-1 to 1642-C₀ and CRCs 1644-1 to 1644-C₀ therefor. The remaining CBGs 1630-1 to 1630-G may have a similar structure to CBG#0 1630-1. The CBGs 1630-1 to 1630-G are divided into a plurality of CBG groups including one or more CBGs, and one CBG group includes one PTB or one STB.

In the example of FIG. 16, CBG#0 1630-1 includes the PTB 1652 and the CRC 1654 for PTB 1652, and CBG#1 1630-2 includes STB#1 1656-1 and CRC 1658-1 for STB#1 1656-1. In addition, CBG#g 1630-(g+1) to CBG#G-1 1630-G include STB#N-1 1656-(N-1) and CRC 1658-(N-1) for STB#N-1 1656-(N-1). The PTB 1652 includes a primary MAC PDU 1662. A plurality of STBs 1656-1 to 1656-(N-1) includes secondary MAC PDUs 1666-1 to 1666-(N-1), respectively.

The primary MAC PDU 1662 includes MAC sub PDUs 1672-1 to 1672-(N-1) for STBs 1656-1 to 1656-(N-1) and other MAC sub PDUs 1674-1 to 1674-K. Each of the other MAC sub PDUs 1674-1 to 1674-K includes MAC CE, MAC SDU, or padding other than control information of the STBs 1656-1 to 1656-(N-1). Each of the MAC sub PDUs 1672-1 to 1672-(N-1) for STBs includes control information of the corresponding STB. The control information of the STB is transmitted in the form of a MAC sub PDU of the PTB 1652. The MAC sub PDUs 1672-1 to 1672-(N-1) including the control information of the STB may be distinguished from other MAC sub PDUs 1674-1 to 1674-K by logical channel ID (LCID).

For example, the MAC sub PDU 1672-1 for STB#1 1656-1 includes MAC subheader 1682, STB ID 1684, STB length 1686, and STB MCS 1688. Here, at least one of the STB ID 1684 or the STB MCS 1688 may be omitted. The MAC subheader 1682 includes LCID. According to one embodiment, the LCID is set to a value allocated to indicate control information of the STB. The STB ID 1684 includes an ID value corresponding to each STB. According to one embodiment, the number and order of the MAC sub PDUs 1672-1 to 1672-(N-1) including the control information of the STB included in the PTB 1652 and the STBs corresponding thereto are defined to be always the same, the STB ID 1684 may be omitted. The STB length 1686 indicates the size of STB#1 1656-1 in bytes. The STB MCS 1688 includes the modulation order, coding scheme, and coding rate applied to CBG#1 1630-2 including STB#1 1656-1.

The MAC sub PDUs for STBs other than STB#1 1656-1 may also include MAC subheader, STB ID, STB length, and STB MCS, similarly to the MAC sub PDU 1672-1. According to one embodiment, whether or not the STB MCS field is included may vary according to the STB. For example, among STBs, the MAC sub PDU for the STB to which an MCS different from the PTB is applied includes an STB MCS field, and the MAC sub PDU for the STB to which the same MCS as the PTB is applied may not include an STB MCS field. In this case, the MAC subheader may include information indicating whether or not to include the STB MCS field. For example, a MAC sub PDU that includes the STB MCS field and a MAC sub PDU that does not include the STB MCS field may be distinguished using different LCID values. As another example, information indicating whether the STB MCS field is included may be distinguished using a field defined to indicate whether the STB MCS field is included.

According to the structure described with reference to FIG. 16, transmission control information of CBG#0 1630-1 including the PTB 1652 is transmitted through the DCI 1610. The PTB length 1615 may be predefined through the standard or signaled based on a mapping table provided through an RRC message, in order to reduce the number of bits. The mapping table may include information related to the structures of the code block group including the PTB corresponding to the length values of the supported PTB. [Table 2] below is an example of a relationship between PTB length 1615 information of the DCI 1610 and CBG#0 1630-1 including the PTB 1652.

TABLE 2

| PTB length | CBG#0 transmission structure | |
|---|---|---|
| indicator | CB length (bits) | CB number |
| 00 | 512 | 1 |
| 01 | 512-L_{CB-CRC} | 2 |
| 10 | 1024-L_{CB-CRC} | 2 |
| 11 | 1024-L_{CB-CRC} | 3 |

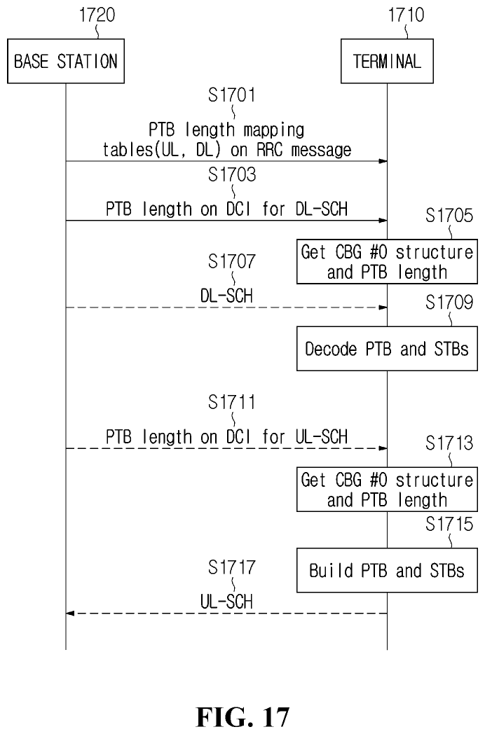

In [Table 2], L_{CB-CRC} denotes the length of code block CRC. An example of a procedure of processing the PTB length 1615 at the base station and the terminal is shown in FIG. 17.

FIG. 17 is a diagram showing an example of a procedure of processing length information of a first-type transport block according to an embodiment of the present disclosure. In FIG. 17, the first-type transport block is referred to as PTB.

Referring to FIG. 17, in step S1703, the base station 1720 transmits an RRC message including a PTB length mapping table to the terminal 1710. The PTB length mapping table may include mapping information between a PTB length indicator and a CBG (hereinafter ‘CBG#0’) structure including the PTB, as shown in [Table 2]. The CBG structure includes CB length and CB number. At this time, the mapping table may be defined differently for each uplink and downlink. In this case, the RRC message may include a plurality of mapping tables. If available mapping table candidates are predefined by the rule, the RRC message may include an index of at least one mapping table.

In step S1703, the base station 1720 transmits a DCI including information related to the PTB length, to the terminal 1710, as a DCI for a DL-SCH. The information related to the PTB length includes an indicator included in the mapping table. That is, the base station 1720 determines the structure of CBG#0 to be used to transmit the DL-SCH and transmits an indicator corresponding to the selected structure through the DCI.

In step S1705, the terminal 1710 identifies the structure of CBG#0 and the PTB length from the DCI. In addition, the terminal 1710 may obtain, from the DCI, the location and size of resource allocated for a PDSCH mapped to the DL-SCH and other information necessary to decode the DL-SCH.

In step S1707, the base station 1720 transmits the DL-SCH to the terminal 1710. The DL-SCH may further include not only a PTB but also at least one STB. The base station 1720 transmits the PTB and the at least one STB through a PDSCH indicated by the DCI. The base station 1720 generates a PTB and CBG#0 corresponding thereto according to the structure determined in step S1703 and then transmits them.

In step S1709, the terminal 1710 decodes the PTB and the at least one STB. Information necessary to decode the PTB may be obtained from the DCI, and information necessary to decode the at least one STB may be obtained from at least one of the DCI or the PTB.

In step S1711, the base station 1720 transmits a DCI including information related to the PTB length to the terminal 1710, as the DCI for a UL-SCH. The information related to the PTB length includes an indicator included in the mapping table. In other words, when the base station 1720 schedules UL-SCH transmission, the base station 1720 determines the structure of CBG#0 to be used to transmit the UL-SCH, and transmits an indicator corresponding to the structure selected through the DCI.

In step S1713, the terminal 1710 identifies the structure of CBG#0 and the PTB length from the DCI. In addition, the terminal 1710 may obtain, from the DCI, the location and size of resource allocated for a PDSCH mapped to the UL-SCH and other information necessary to encode the UL-SCH.

In step S1715, the terminal 1710 builds a PTB and at least one STB. At this time, the terminal 1710 may determine encoding parameters for at least one STB. That is, the terminal 1710 builds a PTB based on information included in the DCI and builds at least one STB based on information determined by the terminal 1710.

In step S1717, the terminal 1710 transmits the UL-SCH including the PTB and the at least one STB to the base station 1720. The terminal 1710 transmits the PTB and the at least one STB through a PUSCH indicated by the DCI.

According to the structure described with reference to FIG. 16, the MCS information of the STB is included in the PTB, not the DCI. In this case, for precise control of QoS for each STB, the system may individually signal the modulation order and coding scheme in place of the index of the MCS table, even if the amount of information increases. For example, as the modulation order, QPSK, 16QAM, 64QAM, and 256QAM may be respectively signaled using indices 0, 1, 2, and 3, and the coding scheme may be signaled using an integer value of ‘target code rate×1024’. Through this, the modulation order and coding scheme of each of the PTB and STBs may be set differently. In this case, radio resources used to transmit the PTB and the STB may be allocated in units of modulation symbols.

According to various embodiments, the MCS table for the STB may be the same as or different from the MCS table for the PTB. The MCS table for the STB and the MCS table for the PTB are prescribed to be fixedly the same or different by the standard, or the system supports both methods but may be selectively applied depending on the capabilities of the terminal or the situation of the base station.

According to one embodiment, the STB may be based on an STB-specific MCS table, which is different from the PTB. In other words, the MCS of the STB may be signaled using the index of the STB-specific MCS table. The STB-specific MCS table may be predefined by standards, etc., or may be forwarded from the base station to the terminal through an RRC message, etc.

If a change in channel is small enough while the PTB and STB are transmitted, the MCS information of the PTB and STB may have a high correlation. Therefore, according to one embodiment, if the MCS tables of the PTB and STB are the same, in order to reduce the number of bits required for MCS signaling of the STB, the MCS of the STB may be expressed as a relative value compared to the MCS of the PTB. For example, if the MCS of the PTB and STB are signaled using the index value of the MCS table defined in the standard, the MCS of the STB may be expressed as an offset value compared to the MCS index of the PTB.

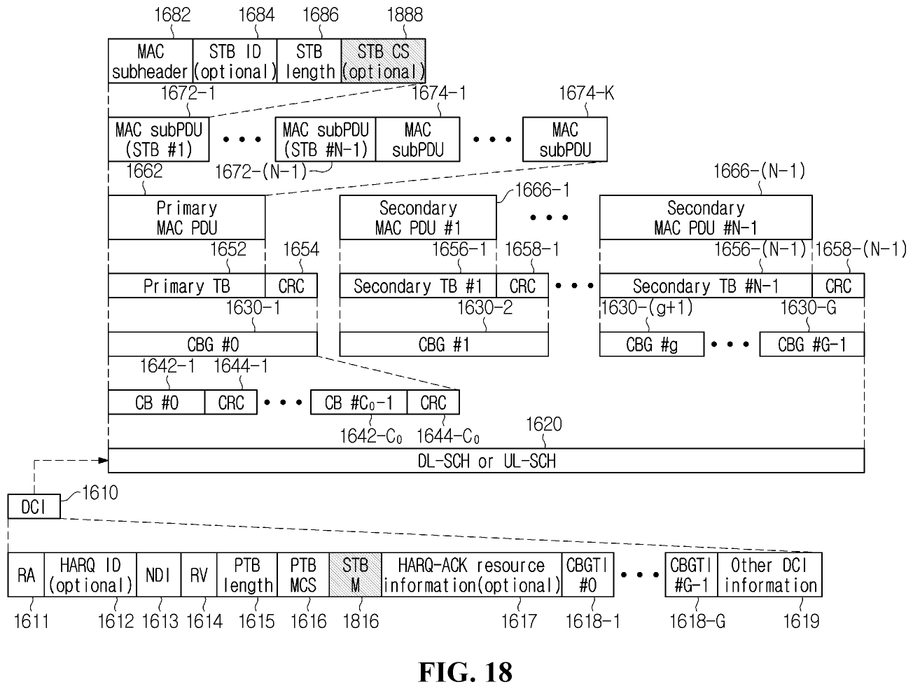

According to the structure described with reference to FIG. 16, the modulation order of the STB is checked after decoding the PTB. Accordingly, when the modulation orders of the PTB and each STB are different, it may be difficult to perform at least part of the demodulation process for the STB until decoding of the PTB is completed. This may increase the transmission latency of the STB and make low-latency transmission difficult. Therefore, according to another embodiment, if the same modulation order is always applied to all STBs and the modulation order of the STB is transmitted through a DCI, demodulation of the STB may be performed only with DCI information regardless of whether the PTB is decoded. The MAC/PHY data structure for transmitting the modulation order of the STB through the DCI is shown in FIG. 18 below.

FIG. 18 is a diagram showing another example of a MAC/PHY data structure according to an embodiment of the present disclosure. FIG. 18 exemplifies a structure in which the MCS of an STB is divisionally transmitted, that is, the modulation order is transmitted using a DCI and a coding scheme is transmitted using a MAC sub PDU of a PTB. Compared to the example of FIG. 16, the DCI 1610 further includes an STB modulation (M) 1816 indicating the modulation order of transmitted STBs. In addition, the MAC sub PDU 1672-1 for STB#1 1656-1 includes MAC subheader 1682, STB ID 1684 and STB length 1686 and instead of the STB MCS 1688, further includes an STB coding scheme 1888 indicating a coding scheme and coding rate of STB#1 1656-1.

According to another embodiment, when the PTB and all STBs are prescribed to always be transmitted with the same modulation order, demodulation of the STB is performed using the modulation order of the PTB without separately transmitting the modulation order information of the STB.

In wireless communication systems such as 4G 7 and 5G NR, in the case of downlink, the terminal provides channel information (channel state information, CSI) to the base station, but in the case of uplink, the base station does not provide channel information to the terminal. This is because the base station forwards resource required for uplink transmission to the terminal through a DCI and thus the terminal does not require channel quality from the base station receiver. Accordingly, the base station estimates channel information between the terminal transmitter and the base station receiver based on pilot signals such as a sounding reference signal (SRS) transmitted by the terminal, determines radio resource and MCS capable of securing a target BLER based on the estimated channel information, and forwards the determined radio resource and MCS to the terminal through a DCI.

According to various embodiments, a plurality of transport blocks with different QoS requirements, that is, a PTB and at least one STB, may be transmitted based on one DCI. If a scheme where the base station determines and indicates MCS applied to uplink is employed as it is, the DCI shall indicate the MCS for all STBs as well as the PTB. That is, when transmitting a plurality of STBs with different QoS requirements, if the MCS of all STBs is scheduled at the base station, a problem may occur in which the amount of DCI information to be forwarded to the terminal increases. Accordingly, the present disclosure proposes embodiments in which the base station schedules and signals only the MCS of the PTB, and the terminal adaptively selects the MCS of each STB according to QoS. Since the terminal does not possess uplink channel information, according to one embodiment, the terminal may select the MCS of the STB based on the MCS of the PTB. At this time, MCS selection criteria for each QoS are needed so that the base station receiver may obtain necessary QoS.

According to one embodiment, the base station may inform the terminal of the MCS of the STB relative to the PTB for each QoS through signaling of an RRC message and MAC CE. Accordingly, the terminal may select the MCS of the STB from the MCS of the PTB. The base station may forward the channel coding algorithm and the MCS of the STB relative to the PTB to the terminal for each LCG.

If the modulation orders of the PTB and each STB are allowed to vary, the base station may transmit, to the terminal, information on the MCS index offset value for each LCG, as shown in [Table 3].

TABLE 3

| LCG ID | MCS Index Offset |
|---|---|
| 0 | 3 |
| 1 | 5 |
| 2 | −1 |
| 3 | 2 |

The terminal may determine the MCS index I_{STB,i} of STB#i by adding the MCS index offset O_{STB,i} of STB#i to the MCS index I_{PTB} of the PTB. O_{STB,i} means the MCS index offset corresponding to the ID of the LCG transmitted through STB#i in [Table 3]. The determination of I_{STB,i} may be expressed as shown in [Equation 1] below.

$${I}_{S T B , i} = max ( {I}_{min ,} min ( {I}_{max} , {I}_{P T B} + {O}_{STB , i} ) ) \qquad [ Equation 1 ]$$

In [Equation 1], I_{STB,i} denotes the MCS index of STB#i, Iₘᵢₙ denotes the minimum value of the MCS index, Iₘₐₓ denotes the maximum value of the MCS index, I_{PTB} denotes the MCS index of the PTB, and O_{STB,i} denotes the MCS index offset corresponding to the LCG ID of the LCG included in STB#i.

When the modulation orders of STBs corresponding to one PTB are prescribed to be the same, the base station may inform the terminal of a code rate multiplication factor for compensating for a difference in modulation order between the PTB and the STB and a code rate multiplication factor for each LCG shown in [Table 4] and [Table 5] below.

TABLE 4

| (M_{STB}-M_{PTB})/2 | Code Rate Multiplication Factor α |
|---|---|
| −3 | 1.6 |
| −2 | 1.3 |
| −1 | 1.1 |
| 0 | 1.0 |
| 1 | 0.9 |
| 2 | 0.7 |
| 3 | 0.4 |

In [Table 4], M_{PTB} and M_{STB} are the modulation orders of the PTB and the STB, respectively, and 2, 4, 6, and 8 correspond to QPSK, 16QAM, 64QAM, and 256QAM, respectively.

TABLE 5

| LCG ID | Code Rate Multiplication Factor β |
|---|---|
| 0 | 1.3 |
| 1 | 1.5 |
| 2 | 0.5 |
| 3 | 1.2 |

The terminal may determine the coding rate of STB#i by multiplying the PTB coding rate by the coding rate multiplication factor that compensates for the difference in modulation order and the coding rate multiplication factor of the LCG transmitted through the STB, as shown in [Equation 2] below.

$${R}_{STB , i} = max ( {R}_{min} , min ( {R}_{max} , {R}_{P T B} \times {α}_{S T B} \times {β}_{STB , i} ) ) \qquad [ Equation 2 ]$$

In [Equation 2], R_{STB,i} denotes the coding rate of STB#i, Rₘᵢₙ denotes the minimum value of the coding rate, Rₘₐₓ denotes the maximum value of the coding rate, R_{PTB} denotes the coding rate of the PTB, α_{STB} denotes the coding rate multiplication factor, β_{STB,i} denotes the coding rate multiplication factor of LCG transmitted through STB#i.

According to one embodiment, when the PTB and all STBs are prescribed to always be set to the same modulation order, the coding rate multiplication (e.g., α_{STB}) according to the modulation order may be defined as a fixed value, and may be set to one of various values according to a difference in QoS requirements, such as the target BLERs of the PTB and the STB.

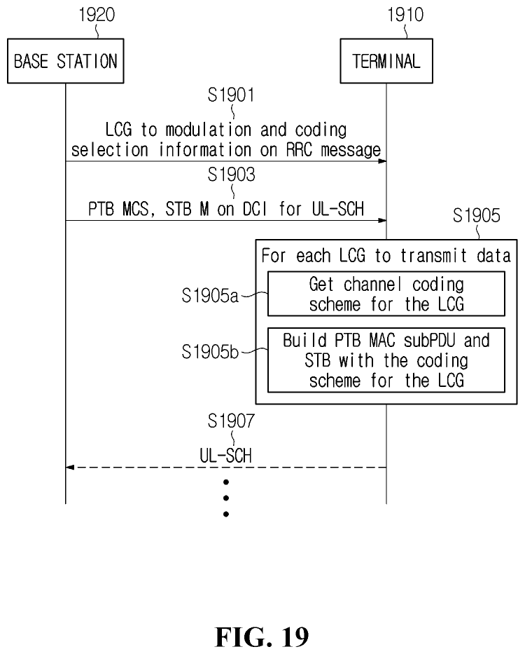

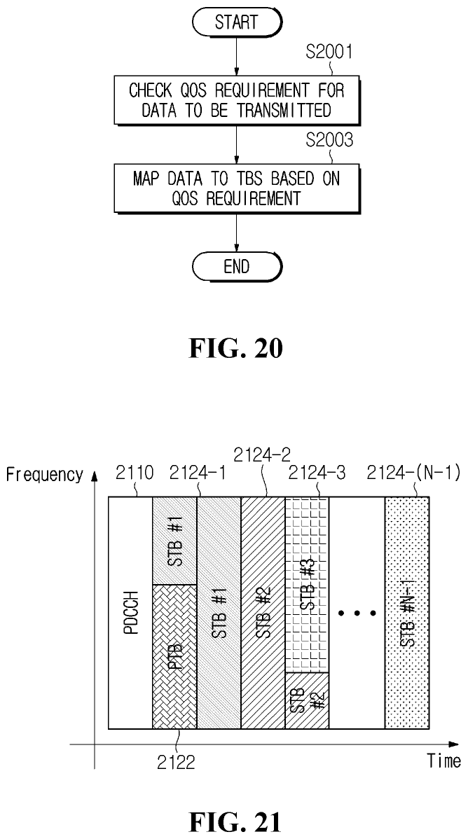

FIG. 19 is a diagram showing an example of a procedure for transmitting data based on a channel coding scheme for each LCG according to an embodiment of the present disclosure. FIG. 19 illustrates a procedure in which a base station transmits MCS index offset or coding scheme information for each LCG to the terminal, and the terminal selects the MCS or coding scheme of each STB based on the received information and PTB MCS. In FIG. 19, the first-type transport block is referred to as PTB, and the second-type transport block is referred to as STB.

Referring to FIG. 19, in step S1901, the base station 1920 transmits an RRC message including modulation and coding selection information for each LCG to the terminal 1910. The modulation and coding selection information for each LCG may include at least one of an offset of the MCS relative to the MCS of the PTB or a coding rate multiplication factor relative to the coding rate of the PTB. Here, the coding rate multiplication factor may include at least one of a first multiplication factor based on the MCS level or a second multiplication factor based on the coding rate. According to another embodiment, modulation and coding selection information for each LCG may be transmitted through a MAC CE.

In step S1903, the base station 1920 transmits to the terminal 1910 a DCI that includes the MCS of the PTB or the MCS of the PTB and the modulation order of the STB, as a DCI for a UL-SCH. That is, according to various embodiments, the modulation order of the STB may be prescribed to be included or not included in the DCI.

In step S1905, the terminal 1910 performs operations of steps S1905a and S1905b below, with respect to data transmitted through each LCG. In step S1905a, the terminal 1910 gets a channel coding scheme for LCG based on the modulation and coding selection information for each LCG and DCI. At this time, if the DCI does not include modulation order information, the terminal 1910 may further get the modulation order for LCG. In step S1905b, the terminal 1910 builds a PTB MAC sub PDU and STB. Here, the PTB MAC sub PDU corresponding to the STB may include at least one of STB ID, STB length, or decoding information of the STB (e.g., modulation order, coding scheme, coding rate). However, since the base station 1920 may also determine the decoding information of the STB (e.g., modulation order, coding scheme, coding rate) through the same operation as the terminal 1910, according to another embodiment, the decoding information (e.g., modulation order, coding scheme, coding rate) of the STB may not be included in the PTB MAC sub PDU. At this time, if decoding information is excluded, the LCID or LCG ID of the data transmitted through the STB may be included.

According to the various embodiments described above, transport blocks or logical channels with various QoS requirements in downlink and uplink may be transmitted based on one PDCCH. At this time, according to QoS requirements, it is necessary to properly map logical channels to transport blocks. Embodiments for mapping between logical channels and transport blocks are as follows.

QoS at the PHY layer is mainly determined by BLER and transmission latency time. Depending on the QoS requirements of the data and the logical channel mapped to each STB, channel coding scheme may be differentially applied based on the target BLER. This may be understood as allocating a greater amount of radio resources to data that requires high reliability and low latency. The success probability of the first transmission of each STB may be expressed as [Equation 3] below.

$$T S {R}_{STB , i} = ( 1 - BLE {R}_{DCI} ) ( 1 - BLE {R}_{P T B} ) ( 1 - BLE {R}_{STB , i} ) \qquad [ Equation 3 ]$$

In [Equation 3], TSR_{STB,i} denotes the success probability of the first transmission of STB#i, BLER_{DCI} denotes the BLER of DCI, BLER_{PTB} denotes the BLER of PTB, and BLER_{STB,i} denotes the BLER of STB#i.

As shown in [Equation 3], the success probability of the first transmission of the STB depends on the BLER of the PTB. Therefore, in order to increase the success probability of the first transmission of the STB, it is desirable to select a channel coding scheme so that the BLER of the PTB is sufficiently low.

In addition, in order to reduce latency time, a method of transmitting data requiring high reliability and low latency through the PTB or STB, which is transmitted earlier in time, may be considered. FIG. 21 is a diagram showing an example of transport block mapping based on latency priority according to an embodiment of the present disclosure. FIG. 21 exemplifies a case where, subsequent to a PDCCH 2110, PTB 2122, STB#1 2124-1, STB#2 2124-2, STB#3 2124-3, . . . , STB#N-1 2124-(N-1) are arranged in this order, on the time axis in the OFDM-based system. In FIG. 21, the frequency resource is expressed as a VRB (virtual resource block), and the PTB or STB transmitted through some frequency resources may be transmitted over the entire frequency domain depending on whether interleaving is applied in the process of mapping to a PRB (physical resource block).

On the other hand, since the PTB and each STB are transmitted through separate CBGs, if only the CBs corresponding to each transport block are decoded without error, the decoded transport block may be forwarded to the MAC without latency and then processed. Therefore, a problem in which processing of a transport block requiring low latency is delayed due to an error occurring in another transport block will not occur.

As described above, when a plurality of transport blocks is related to one DCI, there may also be a change in the HARQ procedure. For example, if an error occurs in a first-type transport block, there is a problem in which decoding of the second-type transport block cannot be performed until the error in the first-type transport block is corrected through retransmission. Therefore, it is desirable that the target BLER of the first-type transport block is set low. However, since errors cannot be completely prevented, there is a need for a method of minimizing decoding latency for the second-type transport block when an error occurs.

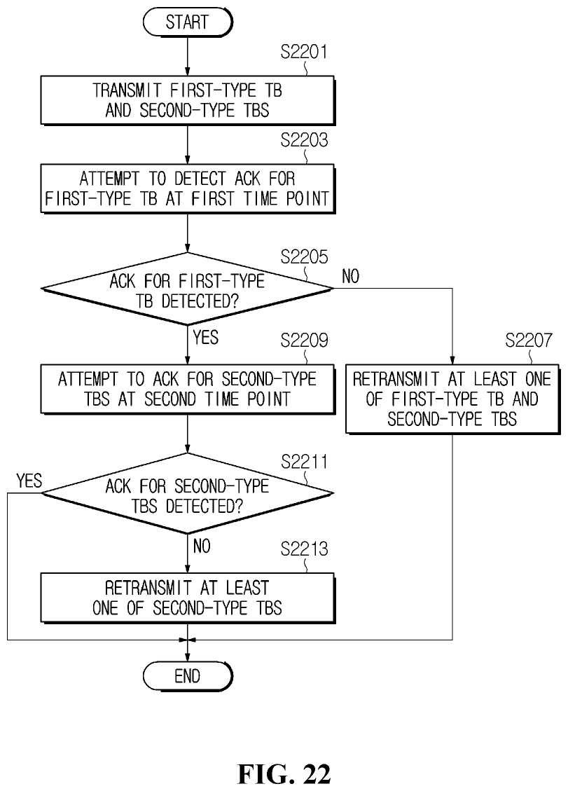

According to one embodiment, transmission latency may be reduced by changing the HARQ-ACK transmission time of the first-type transport block and the second-type transport block. The retransmission procedure according to one embodiment is shown in FIG. 22 below.

FIG. 22 is a diagram showing an example of a method of retransmitting a transport block according to an embodiment of the present disclosure. FIG. 22 illustrates a method performed by an apparatus that transmits data, and the operating subject is referred to as ‘apparatus’. The apparatus may be understood as a base station for downlink communication and a terminal for uplink communication.

Referring to FIG. 22, in step S2201, the apparatus transmits a first-type transport block and second-type transport blocks. That is, the apparatus initially transmits first-type transport blocks and second-type transport blocks. Prior to this, although not shown in FIG. 22, the apparatus may transmit or receive a DCI.

In step S2203, the apparatus attempts to detect ACK for the first-type transport block at a first time point. The ACK timing for attempting to detect ACK may be predefined or set through separate signaling. According to one embodiment, the first time point may be earlier than a time point when transmission of the second-type transport blocks is completed. Alternatively, according to another embodiment, the first time point may be later than the time point when transmission of the second-type transport blocks is completed and may be at least one TTI earlier than the ACK timing for the second-type transport blocks.

In step S2205, the apparatus checks whether ACK for the first-type transport block is detected. That is, the apparatus determines whether decoding of the first-type transport block was successful in a counterpart apparatus.

If ACK for the first-type transport block is not detected, in step S2207, the apparatus retransmits at least one of the first-type transport block or the second-type transport blocks. That is, according to one embodiment, only the first-type transport block may be retransmitted, or, according to another embodiment, both the first-type transport block and the second-type transport blocks may be retransmitted.

On the other hand, when ACKs for first-type transport block are detected, in step S2209, the apparatus attempts to detect ACKs for the second-type transport blocks at a second time point. ACK timing for attempting to detect ACKs may be predefined or set through separate signaling.

In step S2211, the apparatus checks whether ACKs for the second-type transport blocks are detected. That is, the apparatus determines whether decoding of the second-type transport blocks was successful in the counterpart apparatus. When a plurality of second-type transport blocks are transmitted, decoding of some of the plurality of second-type transport blocks may succeed, and decoding of the others may fail. If ACKs for the second-type transport blocks are detected, the apparatus ends this procedure.

On the other hand, if ACK for at least one of the second-type transport blocks is not detected, in step S2213, the apparatus retransmits at least one of the second-type transport blocks.

In the description with reference to FIG. 22, a plurality of second-type transport blocks is described as being transmitted. However, according to another embodiment, the procedure of FIG. 22 may be applied even when one second-type transport block is transmitted.

As in the embodiment described with reference to FIG. 22, the ACK feedback time point for the first-type transport block and the ACK feedback time point for the second-type transport block may be set separately. Accordingly, ACK feedback for the first-type transport block may be rapidly performed, and if decoding of the first-type transport block fails, the error may be rapidly corrected.

In other words, since the information included in the first-type transport block is required to decode the second-type transport block, when the transmitter transmits the first-type transport block first and the receiver preferentially decodes the first-type transport block, it is possible to transmit HARQ-ACK earlier than the reception of the second-type transport block. To this end, the base station may allocate radio resources through a DCI so that the HARQ-ACKs of the first-type and second-type transport blocks are transmitted at different times.

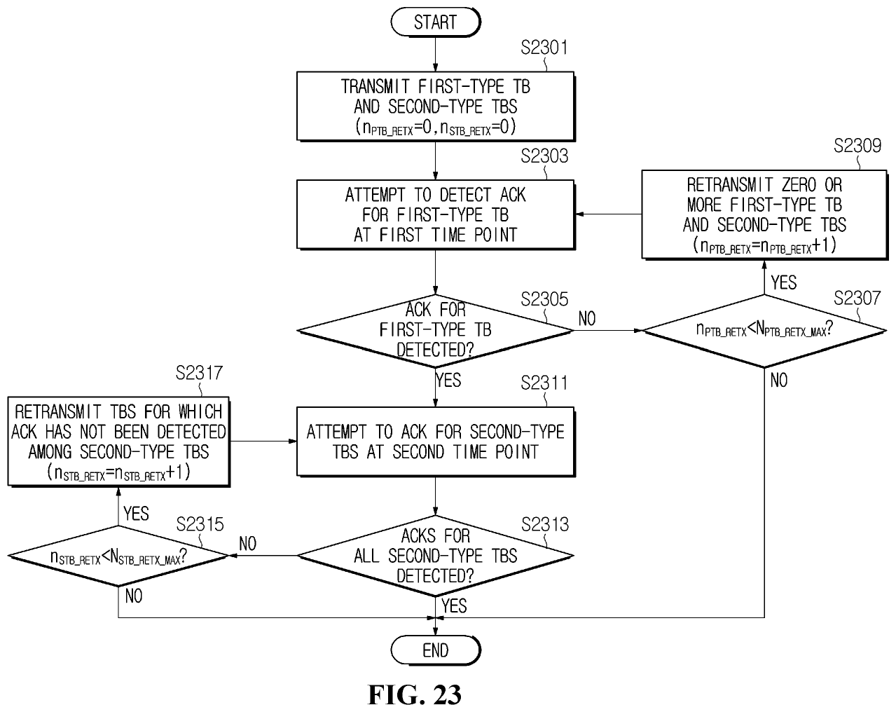

FIG. 22 does not express operation after one retransmission. However, if NACK occurs repeatedly, retransmission may be performed again according to the maximum number of retransmissions. The retransmission procedure considering repetitive retransmission is shown in FIG. 23 below.

FIG. 23 is a diagram showing another example of a method of retransmitting a transport block according to an embodiment of the present disclosure. FIG. 23 illustrates a method performed by an apparatus that transmits data, and the operating subject is referred to as ‘apparatus’. An apparatus may be understood as a base station for downlink communication and a terminal for uplink communication.

Referring to FIG. 23, in step S2301, the apparatus transmits a first-type transport block and second-type transport blocks. That is, the apparatus initially transmits the first-type transport block and second-type transport blocks. During initial transmission, the number of retransmissions of the first-type transport block (hereinafter ‘n_{PTB_RETX}’) is initialized to 0, and the number of retransmissions of the second-type transport blocks (hereinafter ‘n_{STB_RETX}’) is initialized to 0. Prior to this, although not shown in FIG. 23, the apparatus may transmit or receive a DCI.

In step S2303, the apparatus attempts to detect ACK for the first-type transport block at a first time point. The ACK timing for attempting to detect ACK may be predefined or set through separate signaling. According to various embodiments, the first time point is earlier than a time point when transmission of the second-type transport blocks is completed, or later than the time point when the transmission of the second-type transport blocks is completed, and may be at least one TTI earlier than the ACK timing for the second-type transport blocks. In step S2305, the apparatus checks whether ACK for the first-type transport block is detected. That is, the apparatus determines whether decoding of the first-type transport block was successful in a counterpart apparatus.

If ACK for the first-type transport block is not detected, in step S2307, the apparatus determines whether n_{PTB_RETX} is less than the maximum number of retransmissions of the first-type transport block (hereinafter ‘N_{PTB_RETX_MAX}’). If n_{PTB_RETX} is greater than or equal to N_{PTB_RETX_MAX}, the apparatus terminates this procedure. On the other hand, if nPTB_ RETX is less than N_{PTB_RETX_MAX}, in step S2309, the apparatus retransmits the first-type transport block and zero or more second-type transport blocks. At this time, N_{PTB_RETX} is increased by 1. Then, the apparatus returns to step S2303.

On the other hand, if an ACK for the first-type transport block is detected, in step S2311, the apparatus attempts to detect ACKs for the second-type transport blocks initially transmitted at the second time point. ACK timing for attempting to detect ACKs may be predefined or set through separate signaling. In step S2313, the apparatus checks whether ACKs for all second-type transport blocks are detected. In other words, the apparatus checks whether ACKs for all second-type transport blocks transmitted in step S2301 are detected. That is, the apparatus determines whether decoding of second-type transport blocks was successful in the counterpart apparatus. When a plurality of second-type transport blocks is transmitted, decoding of some of the plurality of second-type transport blocks may succeed, and decoding of the others may fail. If all ACKs for all second-type transport blocks are detected, the apparatus ends this procedure.

On the other hand, if ACK for at least one of the second-type transport blocks is not detected, in step S2315, the apparatus determines whether n_{STB_RETX} is less than the maximum number of retransmissions of the second-type transport blocks (hereinafter ‘N_{STB_RETX_MAX}’). If n_{STB_RETX} is greater than or equal to N_{STB_RETX_MAX}, the apparatus ends this procedure. On the other hand, if n_{STB_RETX} is less than N_{STB_RETX_MAX}, in step S2317, the apparatus retransmits at least one second-type transport block for which ACK has not been detected among the second-type transport blocks. Then, the apparatus returns to step S2311.

In the description referring to FIG. 23, a plurality of second-type transport blocks are described as being transmitted. However, according to another embodiment, the procedure of FIG. 23 may be applied even when one second-type transport block is transmitted.

In the embodiment described with reference to FIG. 23, the same maximum number of retransmissions is applied to a plurality of second-type transport blocks. However, according to another embodiment, a plurality of second-type transport blocks are classified into a plurality of groups, and different maximum numbers of retransmissions may be applied to each group. That is, depending on the QoS requirements of the transport block group, a plurality of maximum retransmission numbers may be applied.

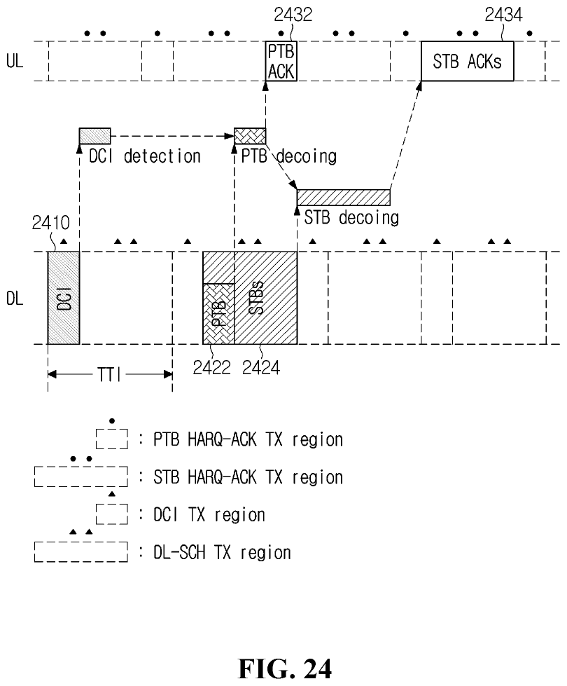

Hereinafter, more specific examples of the HARQ procedure are described with reference to FIGS. 24 to 28. FIGS. 24 to 28 illustrate situations in which multiple QoS DL-SCHs are transmitted when the HARQ-ACK feedback times of a first-type transport block and second-type transport blocks are separated.

FIG. 24 is a diagram showing an example of transmission of transport blocks without decoding failure according to an embodiment of the present disclosure. FIG. 24 illustrates a case in which both DCI and PTB are successfully decoded in the first transmission of multiple QoS DL-SCHs, as a case where NACK does not occur. Referring to FIG. 24, a DCI 2410 is successfully detected, and a DL-SCH including a PTB 2422 and STBs 2424 is transmitted after a specified time offset (e.g., 1 TTI) from the DCI 2410 transmission. The time offset of the DCI 2410 and the DL-SCH may be predetermined by the standard, set by a higher level message such as RRC, or forwarded through scheduling information in the DCI. The terminal obtains DL-SCH scheduling and transmission control information and PTB transmission control information by successfully detecting the DCI 2410, then receives the DL-SCH and attempts to decode the PTB 2422. Upon successful decoding of the PTB 2422, HARQ ACK 2432 for the PTB 2422 is transmitted. Thereafter, the terminal attempts to decode the STBs 2424. In the case of FIG. 24, decoding of the STBs 2424 is successful. Accordingly, the terminal transmits HARQ ACKs 2434 indicating the decoding results for the STBs 2424 to the base station. As shown in FIG. 24, HARQ-ACK for the entire DL-SCH may not be transmitted at the same time, and HARQ-ACK for the PTB 2422 may be transmitted first. The offset of the transmission time of HARQ-ACK for the PTB 2422 and STBs 2424 from the DL-SCH transmission time is predetermined by the standard, set by a higher level message such as RRC, or may be forwarded through HARQ-ACK transmission resource information included in the DCI.

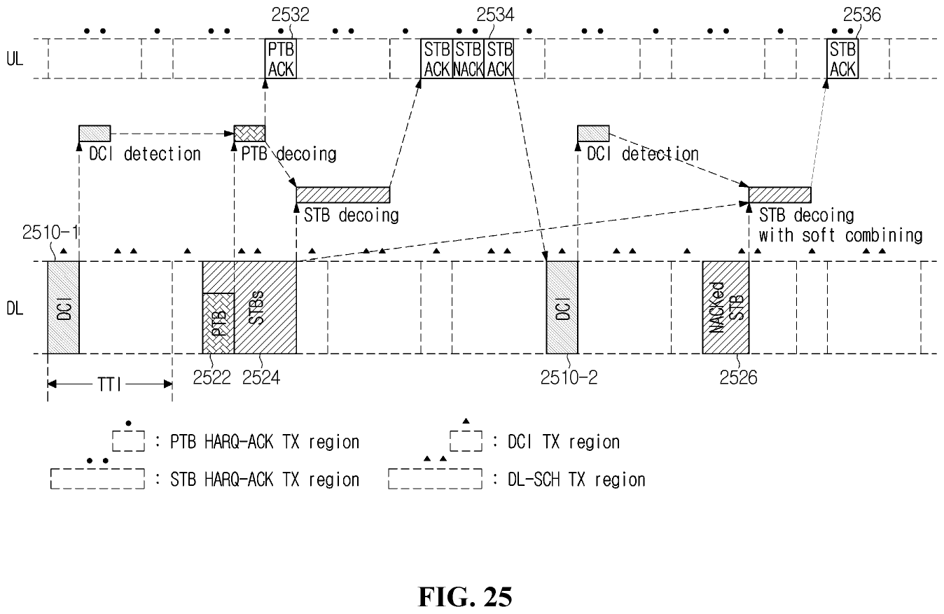

FIG. 25 is a diagram showing an example of transmission of transport blocks when decoding of a second-type transport block fails according to an embodiment of the present disclosure. FIG. 25 illustrates a case where both DCI and PTB were successfully decoded in the first transmission of multiple QoS DL-SCHs, but decoding of one of the STBs failed. Referring to FIG. 25, a DCI 2510-1 is successfully detected, a PTB 2522 is successfully decoded, and HARQ ACK 2532 for the PTB 2522 is transmitted. Thereafter, the terminal attempts to decode the STBs 2524. In the case of FIG. 25, decoding of at least one of the STBs 2524 fails. Accordingly, the terminal transmits HARQ ACK/NACK 2534 indicating the decoding result for STBs 2524 to the base station. Accordingly, the DCI 2510-2 for retransmission of the CBG corresponding to the STB, decoding of which has failed, is transmitted, and the STB 2526, decoding of which has failed, is retransmitted. At this time, decoding of the STB 2526 is successful, and HARQ ACK 2536 indicating successful decoding of the STB 2526 is transmitted.

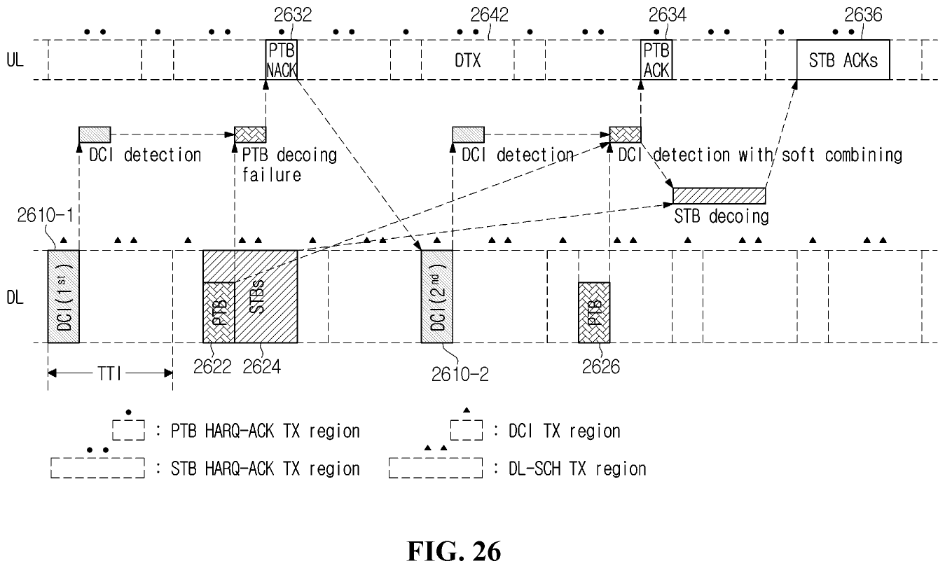

FIG. 26 is a diagram showing an example of transmission of transport blocks when decoding of a first-type transport block fails according to an embodiment of the present disclosure. FIG. 26 illustrates a case where a DCI was successfully decoded in first transmission of multiple QoS DL-SCHs but decoding of a PTB failed. Referring to FIG. 26, a DCI 2610-1 is successfully detected and decoding of a PTB 2622 is attempted. However, as decoding of the PTB 2622 fails, HARQ NACK 2632 for the PTB 2622 is transmitted. Accordingly, a terminal receives STBs 2624, but cannot demodulate and decode them. If modulation order information of the STBs 2624 is included in the DCI 2610-1, the terminal may demodulate the STBs 2624 but cannot decode them. A base station, which has detected HARQ NACK 2632 for the PTB 2622, transmits a DCI 2610-2 for retransmission and then retransmits a PTB 2626. In this case, the terminal combines (e.g., soft combines) the PTB 2622 and the PTB 2626 and attempts decoding again. When decoding of the PTBs 2622 and 2626 is successful, the terminal performs decoding of the STBs 2624 based on the previously received signal.

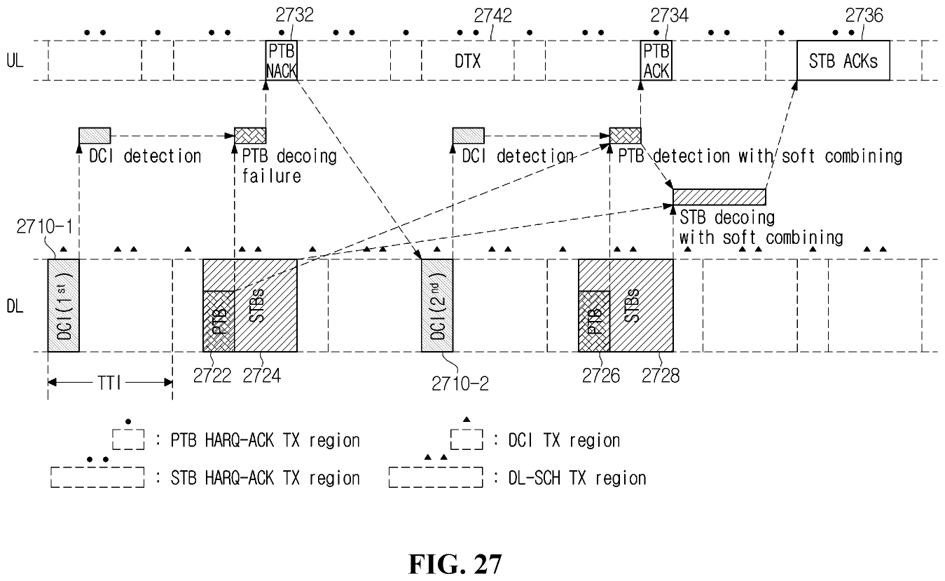

FIG. 27 is a diagram showing another example of transmission of transport blocks when decoding a first-type transport block fails according to an embodiment of the present disclosure. FIG. 27 illustrates a case where a DCI was successfully decoded in first transmission of multiple QoS DL-SCHs, but decoding of a PTB failed. Referring to FIG. 27, a DCI 2710-1 is successfully detected and decoding of a PTB 2722 is attempted. However, as decoding of the PTB 2722 fails. HARQ NACK 2732 for the PTB 2722 is transmitted. Accordingly, a terminal receives STBs 2724, but cannot demodulate and decode them. If modulation order information of the STBs 2724 is included in the DCI 2710-1. the terminal may demodulate the STBs 2724, but cannot decode them. A base station, which has detected HARQ NACK 2732 for the PTB 2722, transmits a DCI 2710-2 for retransmission and then retransmits a PTB and STBs 2728. In this case, the terminal combines (e.g., soft combines) the PTB 2722 and the PTB 2728 and attempts decoding again. When decoding of the PTBs 2622 and 2626 is successful, the terminal combines the previously received STBs 2724 and the STBs 2728 and performs decoding. Unlike the example of FIG. 26, the STBs are retransmitted. In the example of FIG. 27, resources required for retransmission increase but the probability of successful decoding of the STBs increases, thereby decreasing the possibility of additional retransmission and transmission latency.

If decoding of the PTB fails, the terminal may transmit HARQ-NACK or perform DTX processing for the STB. As shown in FIGS. 26 and 27, when decoding of PTB fails, if the UE processes the HARQ feedback of the STB as DTX, the base station may recognize the false detection when detecting PTB-NACK or PTB-DTX as ACK, and have one more opportunity to retransmit the PTB. Whether the terminal transmits HARQ-NACK or performs DTX processing may be set by the base station through an RRC message, etc.

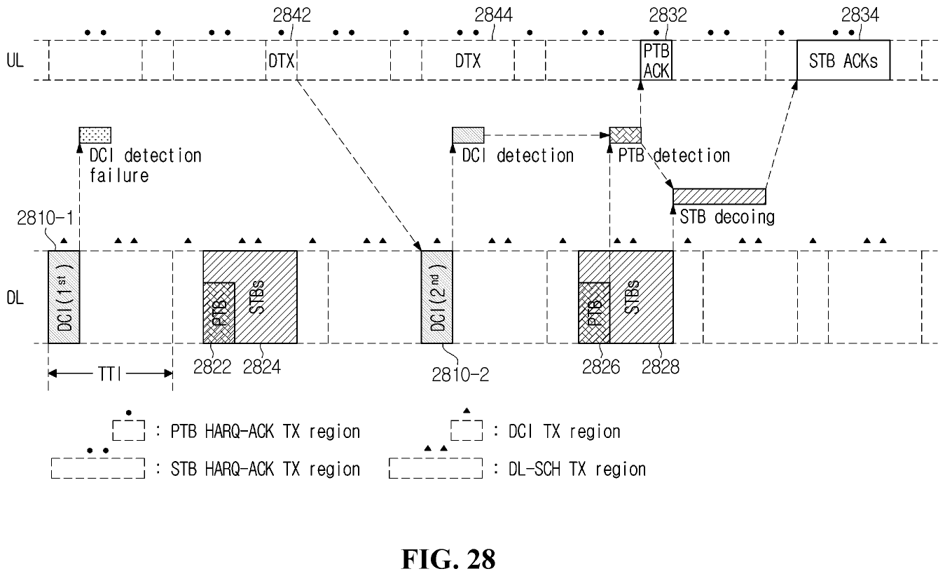

FIG. 28 is a diagram showing an example of transmission of transport blocks when detection of control information fails according to an embodiment of the present disclosure. FIG. 28 illustrates a case where decoding of DCI fails in first transmission of multiple QoS DL-SCHs. Referring to 28, detection of a DCI 2810-1 fails. Because a terminal did not detect the DCI 2810-1, the terminal does not transmit HARQ-ACK for a PTB 2822, and a base station recognizes HARQ feedback for the PTB 2822 as DTX 2842. In addition, the terminal also processes HARQ feedback for STBs 2824 as DTX 2844. In this case, the base station retransmits the entire DL-SCH, i.e., both a PTB 2826 and STBs 2828. In the example of FIG. 28, decoding of the retransmitted PTB 2826 and STBs 2828 is successful, and PTB ACK 2832 and STB ACKs 2834 are transmitted.

As shown in FIG. 28, since the transmission time of PTB HARQ-ACK is earlier than that of STB HARQ-ACK, the base station may recognize the DCI reception failure of the terminal early and perform retransmission. Therefore, retransmission latency can be reduced.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method performed by a base station in a wireless communication system, the method comprising:
transmitting a downlink control information (DCI); and
transmitting a plurality of transport blocks through resources indicated by the DCI,
wherein the plurality of transport blocks comprises a first-type transport block and at least one second-type transport block,
wherein the DCI comprises modulation order and coding rate information of the first-type transport block, and
wherein the first-type transport block comprises coding rate information of the at least one second-type transport block.

2. The method of claim 1, wherein the DCI or the first-type transport block further comprises modulation order information of the at least one second-type transport block.

3. The method of claim 1, wherein each of the plurality of transport blocks corresponds to at least one code block group.

4. The method of claim 1, wherein the DCI comprises length information of the first-type transport block.

5. The method of claim 1,
wherein the first-type transport block comprises control information for each of the at least one second-type transport block, and
wherein the control information comprises at least one of identification information, length information or modulation order information of the second-type transport block.

6. The method of claim 1,
wherein the first-type transport block comprises at least one media access control (MAC) sub protocol data unit (PDU) comprising control information for each of the at least one the second-type transport block, and
wherein the at least one MAC sub PDU comprises a logical channel identifier (LCID) set to a value allocated to indicate control information for the second-type transport block.

7. The method of claim 1, further comprising:
transmitting information related to structures of a code block group comprising the first-type transport block corresponding to length values of the first-type transport block,
wherein the DCI comprises one of the length values.

8. The method of claim 1, wherein a modulation and coding scheme (MCS) of the at least one second-type transport block is signaled using an offset compared to a MCS of the first-type transport block.

9. The method of claim 1, further comprising:
transmitting another DCI allocating uplink resources; and
receiving a plurality of transport blocks through the uplink resources indicated by the other DCI.

10. The method of claim 9, further comprising:
transmitting information related to a rule for determining a modulation order, coding scheme and coding rate of the at least one second-type transport block received through the uplink resources.

11. The method of claim 10, wherein the information related to the rule comprises at least one of an offset of the MCS of the second-type transport block compared to the MCS of the first-type transport block according to a logical channel group (LCG), a coding rate multiplication factor according to a difference in modulation order between the first-type transport block and the second-type transport block or a coding rate multiplication factor according to the LCG.

12. A method performed by a terminal in a wireless communication system, the method comprising:
receiving a downlink control information (DCI); and
receiving a plurality of transport blocks through resources indicated by the DCI,
wherein the plurality of transport blocks comprises a first-type transport block and at least one second-type transport block,
wherein the DCI comprises modulation order and coding rate information of the first-type transport block, and
wherein the first-type transport block comprises coding rate information of the at least one second-type transport block.

13. The method of claim 12, further comprising receiving information related to a rule for determining a modulation order and coding rate of a second-type transport block received through uplink resources.

14. The method of claim 12, further comprising:
receiving another DCI allocating uplink resources;
modulating and encoding a first-type transport block based on a first modulation order and a first coding rate indicated by the other DCI;
modulating and encoding at least one second-type transport block based on a second modulation order and a second coding rate determined based on the first modulation order and the first coding rate; and
transmitting the first-type transport block and the at least one second-type transport block through the uplink resources indicated by the other DCI.

15. The method of claim 12, comprising:
transmitting hybrid automatic repeat request (HARQ) acknowledge (ACK)/negative-acknowledge (NACK) for the first-type transport block at a first time point; and
transmitting HARQ ACK/NACK for the at least one second-type transport block at a second time point,
wherein the first time point is at least one transmit time interval (TTI) earlier than the second time point.

16. A base station in a wireless communication system comprising:
a transceiver; and
a processor connected to the transceiver,
wherein the processor is configured to:
transmit a downlink control indicator (DCI); and
transmit a plurality of transport blocks through resources indicated by the DCI,
wherein the plurality of transport blocks comprises a first-type transport block and at least one second-type transport block,
wherein the DCI comprises modulation order and coding rate information of the first-type transport block, and
wherein the first-type transport block comprises coding rate information of the at least one second-type transport block.

17-19. (canceled)
